(19) United States
(12) Patent Application Publication
(10) Pub. No.: US 2015/0363003 A1
(43) Pub. Date: Dec. 17, 2015

(54) SCALABLE INPUT FROM TRACKED OBJECT

(71) Applicant: CRUNCHFISH AB, Malmö (SE)

(72) Inventor: Martin HENRIZ, Lund (SE)

(73) Assignee: CRUNCHFISH AB, Malmö (SE)

(21) Appl. No.: 14/761,663

(22) PCT Filed: Jan. 22, 2014
(86) PCT No.: PCT/SE2014/050069

§ 371 Date: Jul. 17, 2015

(30) Foreign Application Priority Data
Jan. 22, 2013 (SE) 1350066-5

(51) Int. Cl. G06F 3/01; H04N 5/232

(52) U.S. Cl. CPC G06F 3/017; H04N 5/23229

(57) ABSTRACT

A computing device (100, 200) comprising a display (120) and a controller (210), wherein said controller (210) is configured to detect and track an object (H) via a video stream (265) provided by a camera (160, 260), detect a movement (G1, G2) of the object (H), translate said movement (G1, G2) of the object (H) to a resulting movement (M1, M2) of a marker (136) based on a scale, detect a change in distance to the object (H), and adapt said scale accordingly.

### TECHNICAL FIELD

This application relates to a method, a computer-readable medium and a device for providing improved input, and in particular to a method, a computer-readable medium and a device for an improved input for data input in or for controlling a touchless user interface.

### BACKGROUND

Touchless user interfaces have been known since the late 1990s and many solutions have been proposed for how to track an object.

A disadvantage is that the object to be tracked is usually comparatively large. A hand or finger is of considerable size compared to a common display size and especially compared to objects that are displayed on a display. It can therefore be difficult for a user to achieve precise control such as when inputting detailed or complex graphical data or when manipulating objects that are positioned closely to one another.

Especially with disabled user the input of complicated patterns becomes an issue as the disabled may have limited motor skills and is unable to perform input at a required detailed level, especially for devices with small displays.

There is thus a need for a computing device that is capable of providing accurate input even for comparatively large input means.

### SUMMARY

It is an object of the teachings of this application to overcome the problems listed above by providing a computing device comprising a display and a controller, wherein said controller is configured to detect and track an object via a video stream provided by a camera, detect a movement of the object, translate said movement of the object to a resulting movement of a marker based on a scale, detect a change in distance to the object, and adapt said scale accordingly.

Such a computing device provides for a more accurate input.

In one embodiment the controller is further configured to display an enlarged portion of an object adjacent to the marker or of a general area adjacent or surrounding the marker.

It is also an object of the teachings of this application to overcome the problems listed above by providing a method for use in a computing device comprising a display, said method comprising detecting and tracking an object via a video stream provided by a camera, detecting a movement of the object, translating said movement of the object to a resulting movement of a marker based on a scale, detecting a change in distance to the object, and adapting said scale accordingly.

It is a further object of the teachings of this application to overcome the problems listed above by providing a computer readable medium comprising instructions that when loaded into and executed by a controller, such as a processor, in a computing device cause the execution of a method according to herein.

The inventors of the present invention have realized, after inventive and insightful reasoning that by adapting a scaling according to a distance change a user is able to simply and intuitively provide (control) input at a higher accuracy in a non-linear manner thereby providing the higher accuracy without requiring the user to move the object to be tracked large distances, which may be clumsy and cumbersome or simply impossible.

It should be noted that the scaling is a translation of movement scaling, i.e. a scale according to which a detected movement is translated into a displayed movement and not a zoom scaling or a scaling of an object.

The teachings herein find use in control systems for devices having user interfaces such as mobile phones, smart phones, tablet computers, computers (portable and stationary), gaming consoles and media and other infotainment devices.

Other features and advantages of the disclosed embodiments will appear from the following detailed disclosure, from the attached dependent claims as well as from the drawings. Generally, all terms used in the claims are to be interpreted according to their ordinary meaning in the technical field, unless explicitly defined otherwise herein.

All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF DRAWINGS

The invention will be described in further detail under reference to the accompanying drawings in which:

FIGS. 1A, 1B and 1C are schematic views of each a computing device according to the teachings herein;

FIG. 2 is a schematic view of the components of a computing device according to the teachings herein;

FIG. 3 is a schematic view of a computer-readable memory according to the teachings herein;

FIGS. 4A, 4B and 4C show an example embodiment of a computing device according to the teachings herein;

FIGS. 5A and 5B each shows a schematic view of the relationship between a detected movement of a tracked object and a resulting movement of a marker according to an example embodiment according to the teachings herein; and

FIG. 6 shows a flowchart illustrating a general method according to an embodiment of the teachings herein.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

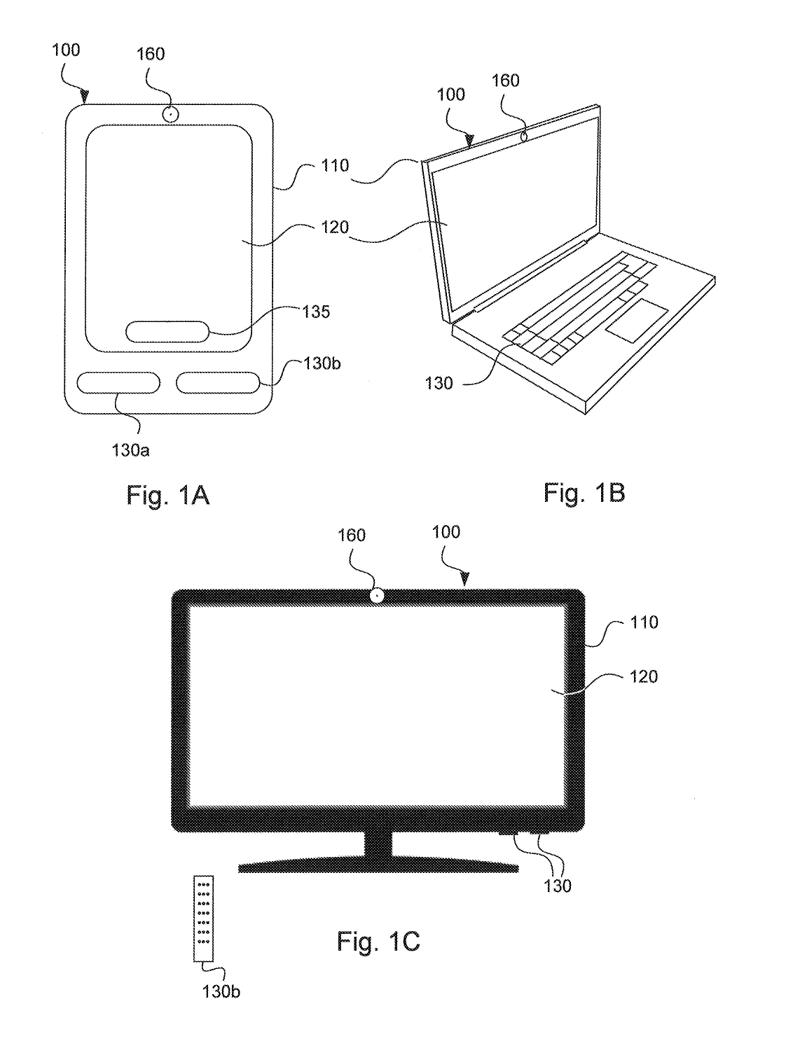

FIG. 1 generally shows a computing device 100 according to an embodiment herein. In one embodiment the computing device 100 is configured for network communication, either wireless or wired. Examples of a computing device 100 are: a personal computer, desktop or laptop, a tablet computer, a mobile communications terminal such as a mobile telephone, a smart phone, a personal digital assistant and a game console. Three embodiments will be exemplified and described as being a smartphone in FIG. 1A, a laptop computer 100 in FIG. 1B and a media device 100 in FIG. 1C. A media device is considered to be a computing device in the context of this application in the aspect that it is configured to receive digital content, process or compute the content and present the resulting or computed media, such as image(s) and/or audio.

Referring to FIG. 1A a mobile communications terminal in the form of a smartphone 100 comprises a housing 110 in which a display 120 is arranged. In one embodiment the display 120 is a touch display. In other embodiments the display 120 is a non-touch display. Furthermore, the smartphone 100 comprises two keys 130a, 130b. In this embodiment there are two keys 130, but any number of keys is possible and depends on the design of the smartphone 100. In one embodiment the smartphone 100 is configured to display and operate a virtual key 135 on the touch display 120. It should be noted that the number of virtual keys 135 are dependant on the design of the smartphone 100 and an application that is executed on the smartphone 100. The smartphone 100 is also equipped with a camera 160. The camera 160 is a digital camera that is arranged to take video or still photographs by recording images on an electronic image sensor (not shown). In one embodiment the camera 160 is an external camera. In one embodiment the camera is alternatively replaced by a source providing an image stream.

Referring to FIG. 1B a laptop computer 100 comprises a display 120 and a housing 110. The housing comprises a controller or CPU (not shown) and one or more computer-readable storage mediums (not shown), such as storage units and internal memory. Examples of storage units are disk drives or hard drives. The laptop computer 100 further comprises at least one data port. Data ports can be wired and/or wireless. Examples of data ports are USB (Universal Serial Bus) ports, Ethernet ports or WiFi (according to IEEE standard 802.11) ports. Data ports are configured to enable a laptop computer 100 to connect with other computing devices or a server.

The laptop computer 100 further comprises at least one input unit such as a keyboard 130. Other examples of input units are computer mouse, touch pads, touch screens or joysticks to name a few.

The laptop computer 100 is further equipped with a camera 160. The camera 160 is a digital camera that is arranged to take video or still photographs by recording images on an electronic image sensor (not shown). In one embodiment the camera 160 is an external camera. In one embodiment the camera is alternatively replaced by a source providing an image stream.

Referring to FIG. 1C a media device, such as a television set, TV, 100 comprises a display 120 and a housing 110. The housing comprises a controller or CPU (not shown) and one or more computer-readable storage mediums (not shown), such as storage units and internal memory, for storing user settings and control software. The computing device 100 may further comprise at least one data port (not shown). Data ports can be wired and/or wireless. Examples of data ports are USB (Universal Serial Bus) ports, Ethernet ports or WiFi (according to IEEE standard 802.11) ports. Such data ports are configured to enable the TV 100 to connect with an external storage medium, such as a USB stick, or to connect with other computing devices or a server.

The TV 100 may further comprise an input unit such as at least one key 130 or a remote control 130b for operating the TV 100.

The TV 100 is further equipped with a camera 160. The camera 160 is a digital camera that is arranged to take video or still photographs by recording images on an electronic image sensor (not shown). In one embodiment the camera 160 is an external camera. In one embodiment the camera is alternatively replaced by a source providing an image stream.

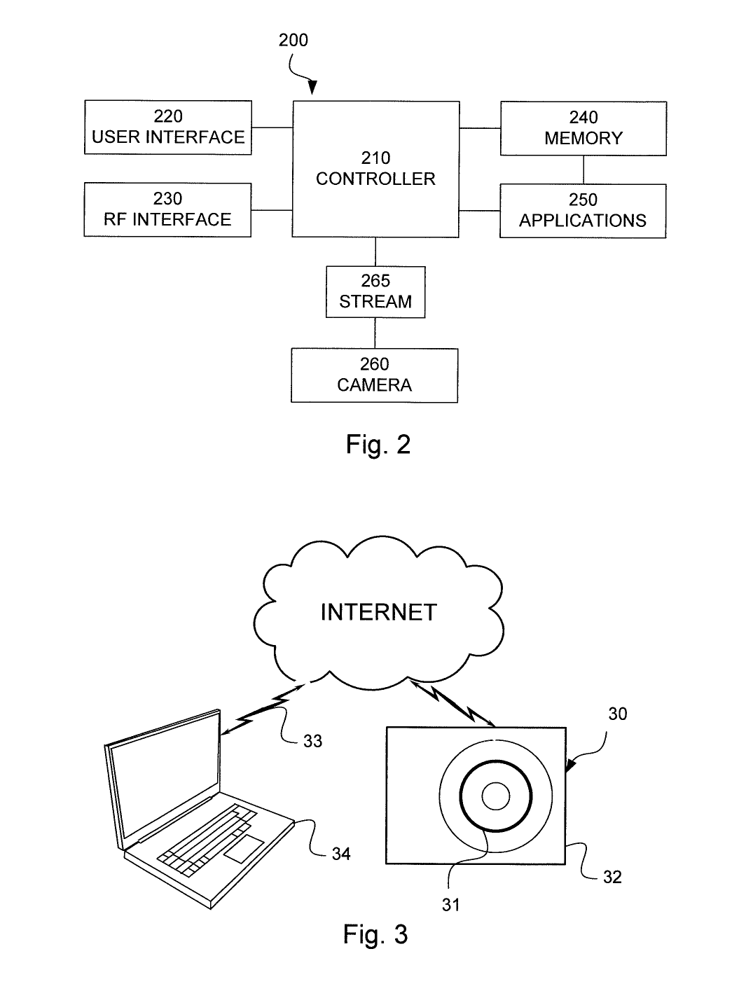

FIG. 2 shows a schematic view of the general structure of a device according to FIG. 1. The device 100 comprises a controller 210 which is responsible for the overall operation of the computing device 200 and is preferably implemented by any commercially available CPU (“Central Processing Unit”), DSP (“Digital Signal Processor”) or any other electronic programmable logic device. The controller 210 is configured to read instructions from the memory 240 and execute these instructions to control the operation of the computing device 100. The memory 240 may be implemented using any commonly known technology for computer-readable memories such as ROM, RAM, SRAM, DRAM, CMOS, FLASH, DDR, SDRAM or some other memory technology. The memory 240 is used for various purposes by the controller 210, one of them being for storing application data and program instructions 250 for various software modules in the computing device 200. The software modules include a real-time operating system, drivers for a user interface 220, an application handler as well as various applications 250.

The computing device 200 further comprises a user interface 220, which in the computing device of FIGS. 1A, 1B and 1C is comprised of the display 120 and the keys 130, 135.

The computing device 200 may further comprises a radio frequency interface 230, which is adapted to allow the computing device to communicate with other devices through a radio frequency band through the use of different radio frequency technologies. Examples of such technologies are IEEE 802.11, IEEE 802.15, ZigBee, WirelessHART, WIFI, Bluetooth®, W-CDMA/HSPA, GSM, UTRAN and LTE to name a few.

The computing device 200 is further equipped with a camera 260. The camera 260 is a digital camera that is arranged to take video or still photographs by recording images on an electronic image sensor (not shown).

The camera 260 is operably connected to the controller 210 to provide the controller with a video stream 265, i.e. the series of images captured, for further processing possibly for use in and/or according to one or several of the applications 250.

In one embodiment the camera 260 is an external camera or source of an image stream.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 3 shows a schematic view of a computer-readable medium as described in the above. The computer-readable medium 30 is in this embodiment a data disc 30. In one embodiment the data disc 30 is a magnetic data storage disc. The data disc 30 is configured to carry instructions 31 that when loaded into a controller, such as a processor, executes a method or procedure according to the embodiments disclosed above. The data disc 30 is arranged to be connected to or within and read by a reading device 32, for loading the instructions into the controller. One such example of a reading device 32 in combination with one (or several) data disc(s) 30 is a hard drive. It should be noted that the computer-readable medium can also be other mediums such as compact discs, digital video discs, flash memories or other memory technologies commonly used.

The instructions 31 may also be downloaded to a computer data reading device 34, such as a laptop computer or other device capable of reading computer coded data on a computer-readable medium, by comprising the instructions 31 in a computer-readable signal 33 which is transmitted via a wireless (or wired) interface (for example via the Internet) to the computer data reading device 34 for loading the instructions 31 into a controller. In such an embodiment the computer-readable signal 33 is one type of a computer-readable medium 30.

The instructions may be stored in a memory (not shown explicitly in FIG. 3, but referenced 240 in FIG. 2) of the laptop computer 34.

References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

An improved manner of receiving input through a scaling of the input will be disclosed below with reference to the accompanying figures. The example will be illustrated focusing on the tracked gestures and the resulting movement displayed on a display, but it should be clear that the processing is performed in part or fully in a computing device comprising a controller as disclosed above with reference to FIGS. 1 and 2 or caused to be performed by executing instructions stored on a computer-readable medium as disclosed with reference to FIG. 3.

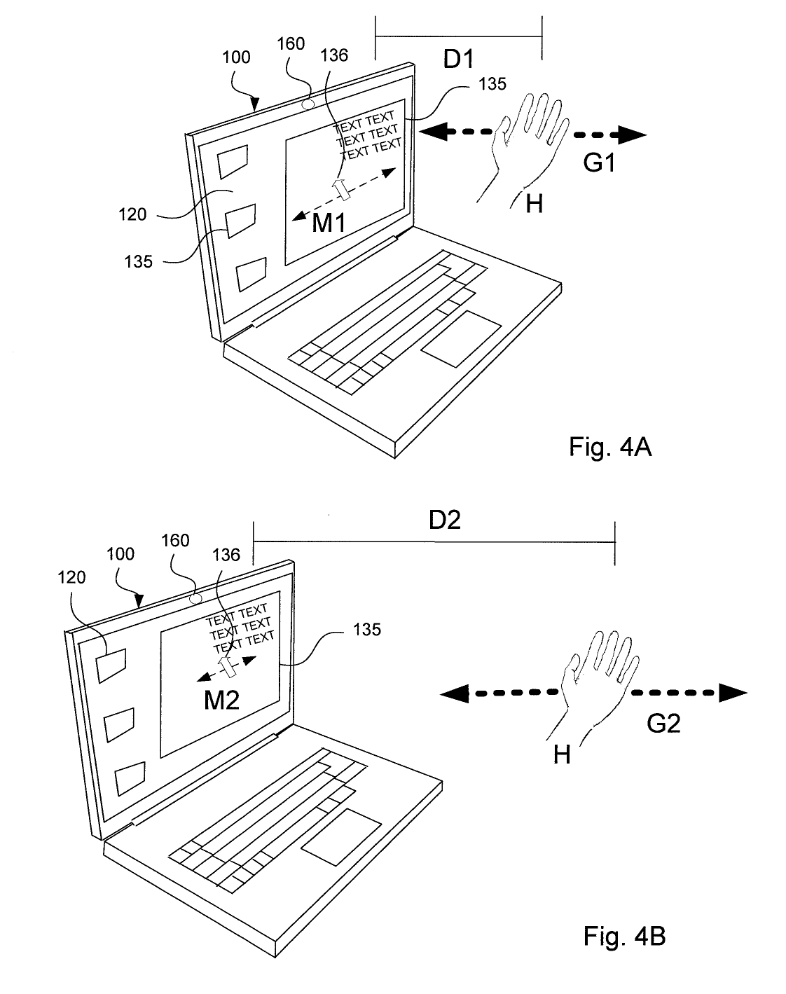

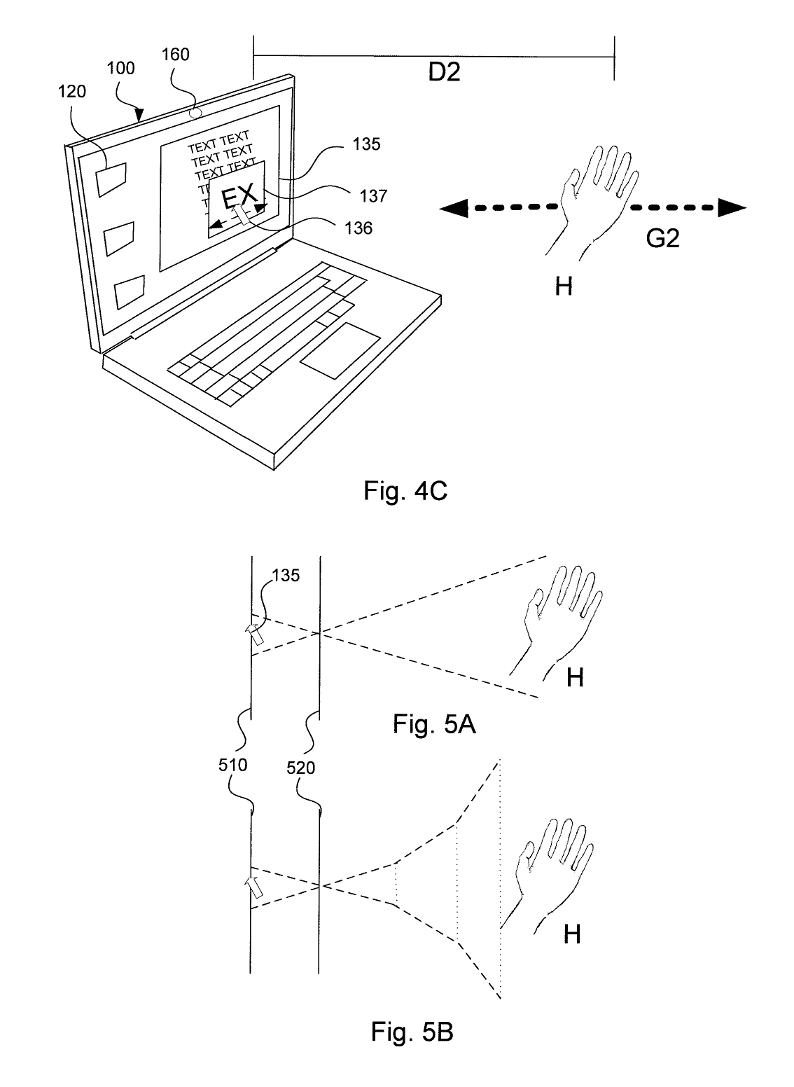

FIG. 4A shows an example of a computing device, in this example a laptop computer 100 as in FIG. 1B, that is configured to detect and track an object, such as a hand H, via a video stream provided by a camera (160). How such an object H is detected and tracked is disclosed in the Swedish patent application SE 1250910-5 and will not be discussed in further detail in the present application. For further details on this, please see the mentioned Swedish patent application. It should be noted, however, that the teachings of the present application may be implemented through the use of other tracking manners than disclosed in Swedish patent application SE 1250910-5.

The laptop computer 100 also has a display 120 on which objects 135 are displayed as well as a marker 136. It should be noted that the description herein will be focused on controlling a marker 136, but it should be noted that the teachings herein may also be utilized for controlling a drawing tool, a text input tool or other tool suitable for use in a graphic user interface.

In one embodiment the laptop computer 100 is configured to detect a movement of the tracked hand H and translate the detected movement to a resulting movement for the marker 136. The laptop computer 100 is configured to scale the detected movement to a scale suitable for the resulting movement. In prior art systems the resulting movement matches the detected movement and the scale of such systems can be said to be 1:1.

Especially in touchless user interfaces the object to be tracked is usually comparatively large. A hand or finger is of considerable size compared to a common display size and especially compared to objects that are displayed on a display. It can therefore be difficult for a user to achieve precise control such as when input detailed or complex graphical data or when manipulating objects that are positioned closely to one another. To allow for a more controlled input the laptop computer 100 is configured to scale the input according to a scale based on the distance or change of distance between an object and the display 120 (or camera 160). In this application there will not be made any difference between the distance between the display 120 and the object H and the distance between the camera 160 and the object H.

In FIG. 4A the hand H is at a first distance D1 from the display 120 and the laptop computer 100 is configured to scale the input received through the tracked hand H at a first scale. The first scale may be 1:1. The first scale may be an initial scale used regardless of what distance the object H is detected at.

In FIG. 4B the hand H has been moved and is now at a second distance D2 from the display 120 and the laptop computer 100 is configured to detect the change in distance (D2-D1) and adapt the scaling accordingly and thereby scale the input received through the tracked hand H at a second scale. The first scale may be 1:2.

FIGS. 4A and 4B illustrate the scaling in a schematic manner. The hand H performs a gesture G1 in FIG. 4ZA which results in a marker movement M1. In FIG. 4B the hand H performs a larger gesture G2 (larger angular distance than G1) which results in a smaller marker movement M2. The detected movement has thus been scaled to increase the accuracy of the control input.

The laptop computer 100 may be configured to detect a distance change through determining that an object H is increased/reduced in size. Alternatively the laptop computer 100 may be configured to detect a distance change through detecting a movement of the tracked hand H in a direction perpendicular to plane of camera 160 or display 120. Details on how such a movement may be detected are disclosed in the Swedish patent application SE 1250910-5 and will not be discussed in further detail in the present application. For further details on this, please see the mentioned Swedish patent application. It should be noted, however, that the teachings of the present application may be implemented through the use of other distance changing detection manners than disclosed in Swedish patent application SE 1250910-5.

As will be discussed with relation to FIGS. 5A and 5B the movements detected may not be measured in absolute distances but rather in angular distances.

The laptop computer 100 will thus divide any detected movement by a factor two when translating the detected movement to the resulting movement. This requires a user to move his hand (or other object to be tracked) H twice the distance to achieve the same resulting movement of the marker 136. This compensates for the comparatively large size of the object to be tracked H and allows for a more precise input in that it is easier to perform complicated gestures at a larger scale.

FIG. 5A shows a schematic prior art view of an object to be tracked, such as a hand H, and a resulting marker 536 being displayed in a display plane 510. It should be noted that the display plane 510 is not the plane of the display 120, but a virtual plane being the plane within the display where objects are to be displayed. The display plane is used to determine perspectives and similar visual effects. A camera plane 520 is also shown schematically in FIG. 5A. The camera plane 520 is not the plane of the camera, but a virtual plane illustrating the location of an image capturing device in relation to the object to be tracked and the resulting marker to be displayed to illustrate the dependency of a tracked object's movement and the resulting movement of the marker 136. The extents of the movements are indicated by the dashed lines. As can be seen, the movements required by the tracked object for a resulting movement is proportional to the distance from the camera plane 520. The further away from the camera plane 520 the hand H is, the longer it needs to move to result in the same resulting movement of the marker 510. This is due to that the hand H is tracked through an angular distance, not an absolute distance.

FIG. 5B shows a schematic view according to an embodiment of the teachings herein of an object to be tracked, such as a hand H, and a resulting marker 536 being displayed in a display plane 510. As can be seen the movement required by the hand H for a specific resulting movement of the marker 136 increases depending on the distance in a non-linear manner. This illustrates the scalability of the input in that a larger angular movement is required to result in the same input. In the example of FIG. 5B the scalability is stepwise, but could also be continuous.

It should be noted that the description is focused on angular distances, but the general teaching herein is equally applicable to a tracking system arranged to detect an absolute distance.

Returning to FIG. 4C, the laptop computer 100 may also or alternatively be configured to display an enlarged portion of any objects 135 adjacent to the marker 136 or of the general area adjacent or surrounding the marker 136. In FIG. 4C a popup window 137 is displayed showing an enlarged version of the text in the underlying window 135.

By providing an enlarged version of the underlying content the user is enabled to provide a more accurate control input.

In one embodiment the provision of an enlarged view 137 is combined with the scaling of the detected movement and is thus comprised in the scaling.

In one embodiment the provision of an enlarged view 137 constitutes the scaling and the zoom factor of the enlarged view corresponds to the scaling factor.

The provision of the enlarged view is not simply a zoom operation in that it also changes the scale of the translation from detected movement to resulting movement.

It should be noted that even though the scaling has been illustrated as being stepwise and dependent on a distance change it should be noted that the teachings herein should not be construed as being limited to detecting a threshold distance, but may be used in conjunction with detecting any distance change.

Also the scaling may be achieved so that any distance change results in a predetermined increase in the scaling.

In one embodiment the distance change is differentiated from distance changes resulting from normal user movements (most users will involuntarily vary the distance also towards the display 120 when performing a gesture) by requiring that the distance change is significant for example with regards to change of size of tracked object, time for movement in direction away from display 120 to name a few possibilities.

In one embodiment the scaling is further dependent on the user. This allows for one user to have a certain scale, perhaps requiring very precise movements, whereas another user may have another scale, perhaps allowing for un-precise, but large, movements. This enables the system to be customized after the experience and abilities of a user.

In one embodiment the scaling is dependent on the tool or marker 136 used or which application is currently being operated. For example, a pen tool in a drawing program may have one scaling setting, whereas a spray can tool may not be enabled for a more precise and accurate input as taught herein. This implements the real world difference between the two emulated tools in that a pen is more accurate than the spray can.

In one embodiment the controller is further configured to detect and track a second object. The second object may also be a hand. In one embodiment the controller is configured for receiving input from the first hand and base an input scale on the input from the first hand, and to receive input from the second hand as control input, possibly limited to a plane parallel to the display plane. This allows a user to, for example, control a cursor with one hand (X,Y) and to control the scale (Z) with the second hand.

The laptop computer 100 is thus configured to, in addition to detecting and tracking the first object H via a video stream 265 provided by a camera 160, 260, also detect and track a second object, detect a movement G1, G2 of the object H and detect a movement of the second object, translate said movement of second the object to a resulting movement M1, M2 of a marker 136 based on a scale, detect a change in distance to the first object H based on the detected movement G1, G2 of the first hand H, and adapt said scale accordingly.

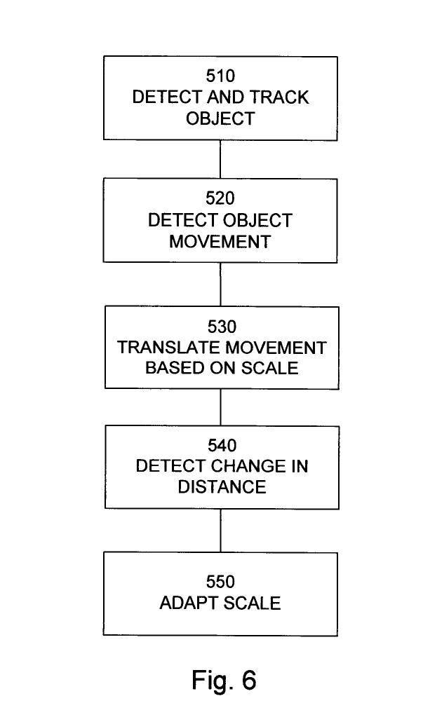

FIG. 6 shows a flowchart of a general method according to the teachings herein. A computing device detects and tracks 610 an object, such as a hand. A movement of the hand is detected 520 and translated 530 into a resulting movement of a marker based on a scale. The computing device detects a change in distance 540 and in response thereto adapts the scale 550 to allow for a more accurate input.

The teachings herein provide the benefit that a more accurate input is achieved.

Another benefit lies in that a user is provided with an intuitive manner of adjusting the precision of his input based on his movements and the computing device's sensibility.

Yet another benefit lies in that a user is enabled to use a user space that is larger than the space in front of the display, thereby increasing the usability of the devices.

The invention has mainly been described above with reference to a few embodiments. However, as is readily appreciated by a person skilled in the art, other embodiments than the ones disclosed above are equally possible within the scope of the invention, as defined by the appended patent claims.

1. A computing device (100, 200) comprising a display (120) and a controller (210), wherein said controller (210) is configured to:
detect and track an object (H) via a video stream (265) provided by a camera (160, 260);
detect a movement (G1, G2) of the object (H);
translate said movement (G1, G2) of the object (H) to a resulting movement (M1, M2) of a marker (136) based on a scale, said scale indicating a length of movement relationship, such as a ratio, between the resulting movement and the detected movement;
detect a change in distance to the object (H); and
adapt said scale accordingly to increase accuracy of the marker movement.

2. The computing device (100, 200) according to claim 1, wherein said controller (210) is further configured to adapt said scale from a first scale to a second scale, wherein the first scale is an initial scale.

3. The computing device (100, 200) according to claim 1, wherein said controller (210) is further configured to display an enlarged portion of an object (135) adjacent to the marker (136) or of a general area adjacent or surrounding the marker (136).

4. The computing device (100, 200) according to claim 3, wherein said display of said enlarged view (137) is comprised in the scaling of the detected movement.

5. The computing device (100, 200) according to claim 3, wherein said display of said enlarged view (137) constitutes the scaling and the zoom factor of the enlarged view corresponds to the scaling factor.

6. The computing device (100, 200) according to claim 1, wherein said controller (210) is further configured to adapt said scale continuously.

7. The computing device (100, 200) according to claim 1, wherein said controller (210) is further configured to adapt said scale stepwise.

8. The computing device (100, 200) according to claim 1, wherein said controller (210) is further configured to detect a distance change by detecting a movement in a direction perpendicular to the plane of the display (120).

9. The computing device (100, 200) according to claim 1, wherein said controller (210) is further configured to:
in addition to detecting and tracking the first object (H) via a video stream (265) provided by a camera (160, 260), also detect and track a second object;
detect a movement (G1, G2) of the object (H) and detect a movement of the second object;
translate said movement of second the object to a resulting movement (M1, M2) of a marker (136) based on a scale;
detect a change in distance to the first object (H) based on the detected movement (G1, G2) of the first hand (H); and
adapt said scale accordingly.

10. A method for use in a computing device (100, 200) comprising a display (120), said method comprising:
detecting and tracking an object (H) via a video stream (265) provided by a camera (160, 260);
detecting a movement (G1, G2) of the object (H);
translating said movement (G1, G2) of the object (H) to a resulting movement (M1, M2) of a marker (136) based on a scale, said scale indicating a length of movement relationship, such as a ratio, between the resulting movement and the detected movement;
detecting a change in distance to the object (H); and
adapting said scale accordingly to increase accuracy of the marker movement.

11. A computer readable storage medium (40) encoded with instructions (41) that, when loaded and executed on a processor, causes the method according to claim 10 to be performed.

12. The computing device (100, 200) according to claim 2, wherein said controller (210) is further configured to display an enlarged portion of an object (135) adjacent to the marker (136) or of a general area adjacent or surrounding the marker (136).

13. The computing device (100, 200) according to claim 2, wherein said controller (210) is further configured to adapt said scale continuously.

14. The computing device (100, 200) according to claim 3, wherein said controller (210) is further configured to adapt said scale continuously.

15. The computing device (100, 200) according to claim 4, wherein said controller (210) is further configured to adapt said scale continuously.

16. The computing device (100, 200) according to claim 5, wherein said controller (210) is further configured to adapt said scale continuously.

17. The computing device (100, 200) according to claim 2, wherein said controller (210) is further configured to adapt said scale stepwise.

18. The computing device (100, 200) according to claim 3, wherein said controller (210) is further configured to adapt said scale stepwise.

19. The computing device (100, 200) according to claim 4, wherein said controller (210) is further configured to adapt said scale stepwise.

20. The computing device (100, 200) according to claim 5, wherein said controller (210) is further configured to adapt said scale stepwise.
